(19) United States
(12) Patent Application Publication
(10) Pub. No.: US 2007/0056682 A1
(43) Pub. Date: Mar. 15, 2007

(54) Method for producing complex phase retarder and complex optical member

(75) Inventors: Kenji Yamada, Niihama-shi (JP); Tohru Nagashima, Niihama-shi (JP); Yoshiki Matsuoka, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/519,862

(22) Filed: Sep. 13, 2006

(30) Foreign Application Priority Data
Sep. 15, 2005 (JP) 2005-268017

(51) Int. Cl. B32B 37/00

(52) U.S. Cl. 156/249; 349/117

(57) ABSTRACT

The present invention provides a method for producing a complex phase retarder comprising a first phase retarder of at least one resin film, an adhesive layer and a second phase retarder of a coating layer laminated in this order, the method comprising: preparing a phase retarder with an adhesive where an adhesive layer is formed on a surface of a first phase retarder; applying on a transfer base a coating liquid containing an organic modified clay compound of which the chlorine content is no greater than 2,000 ppm and a binder resin in an organic solvent where the moisture ratio measured using a Karl Fischer's moisture meter is 0.15 wt % to 0.35 wt %; forming a second phase retarder by removing the organic solvent and the water from the applied coating liquid; bonding an exposed surface of the above described second phase retarder to the adhesive layer side of the above described phase retarder with an adhesive; peeling the transfer base from the above described second phase retarder; and forming a second adhesive layer on the surface of this second phase retarder from which the transfer base was peeled.

### FIELD OF THE INVENTION

The present invention relates to a method for producing a complex phase retarder which is thin and lightweight, has excellent view angle properties and is appropriate for use in the formation of a liquid crystal display for mobile apparatuses. The present invention also relates to a method for producing a complex optical member where an additional optical layer is layered on such a complex phase retarder.

### BACKGROUND OF THE INVENTION

In recent years, lightweight and thin liquid crystal displays (LCD's) of which the power consumption is low and which can be driven at a low voltage have been rapidly spreading as information display devices, for example monitors for cellular phones, portable information terminals and computers, as well as televisions. As liquid crystal technology has been progressing, liquid crystal displays in various modes have been proposed, and problems with liquid crystal displays in terms of speed of response, contrast and view angle have been resolved. However, it is still pointed out that the view angle is small in comparison with cathode ray tubes (CRT's), and various attempts have been made to widen the view angle.

Nematic type liquid crystal displays (VA-LCD□s) in a vertical orientation mode as that disclosed in, for example, Japanese Patent No. 2548979 (Patent Document 1) have been developed as one liquid crystal display system where the above described view angle properties are improved. Such a vertical orientation mode allows liquid crystal molecules to be oriented perpendicular to the substrate in a non-driven state, and therefore, light transmits through the liquid crystal layer without the polarization changing. For this reason, linear polarizers are placed above and beneath a liquid crystal panel, so that respective polarization axes become perpendicular to each other, and thereby, an almost completely black display can be gained as viewed from the front, and thus, a high contrast ratio can be provided.

However, in liquid crystal displays in a vertical orientation mode, where only a polarizer is provided to a liquid crystal cell as that described above when viewed from diagonally in front, light leaks, making the contrast ratio lower significantly, due to shifting of the axis angle of the polarizer that is provided by 90° and the birefringence of the liquid crystal molecules in rod form within the cell.

In order to prevent leakage of light, it is necessary to place an optical compensation film between the liquid crystal cell and the linear polarizer, and a conventional system where one biaxial phase retarder is placed between the liquid crystal cell and each of the polarizing plates on the top and on the bottom, as well as a system where a uniaxial phase retarder and a complete biaxial phase retarder are placed above and below the liquid crystal cell or the two plates are placed on one side of the liquid crystal cell, have been adopted. JP 2001-109009A (Patent Document 2), for example, describes that an a-plate (that is to say, a positive uniaxial phase retarder) and a c-plate (that is to say, a complete biaxial phase retarder) are placed between the liquid crystal cell and the respective polarizers on the top and on the bottom in a liquid crystal display in a vertical orientation mode.

The positive uniaxial phase retarder is a film where the ratio R₀/R′ of the phase difference value R₀ within the surface to the phase difference value R′ in the direction of the thickness is approximately 2, and the completely biaxial phase retarder is a film where the phase difference value R₀ within the surface is approximately 0. Here, the phase difference value R₀ within the surface and the phase difference value R′ in the direction of the thickness can be defined by the following formulas (I) and (II), respectively, when the index of refraction in the direction of the late phase axis within the surface of the film is nₓ, the index of refraction in the direction of the fast phase axis within the surface of the film is n_{y}, the index of refraction in the direction of the thickness of the film is n_{z} and the thickness of the film is d.
R₀=(nₓ−n_{y})×d (I)
R′=[(nₓ+n_{y})/2−n_{z}]×d (II)

In the positive uniaxial film, n_{z}˜n_{y}, and therefore, R₀/R′˜2. Even in a uniaxial film, R₀/R′ varies between approximately 1.8 and 2.2 due to fluctuation of the conditions for expansion. In a completely biaxial film, nₓ˜n_{y}, and therefore, R₀˜0. Only the index of refraction in the direction of the thickness differs (small) in a completely biaxial film, and therefore, the completely biaxial film is negatively uniaxial and referred to as a film having an optical axis in the normal direction, and in addition, may be referred to as a c-plate, as described above. In a biaxial film, nₓ>n_{y}>n_{z}.

As for the completely biaxial phase retarder used for the above described purpose, JP 10-104428A (U.S. Pat. No. 6,060,183; Patent Document 3) describes that a phase retarder is formed of a layer which includes an organic modified clay compound that can be dispersed in an organic solvent. A complex polarizer where a phase retarder made of such a coating layer is layered on a polarizing plate in a certain form has a simple configuration, and has excellent view angle properties and is easy to handle when applied to a liquid crystal display. In addition, JP 2004-4150A (US 2003/0219549 A1; Patent Document 4) discloses a multilayer phase retarder having biaxial orientation as a whole, where a coat layer having anisotropy in the index of refraction is layered on a transparent resin film substrate having orientation within the film surface. Furthermore, JP 2005-70096A (Patent Document 5) describes that a phase retarder is formed of a coating layer on a mold release film, and after that, this coating layer is layered on a transparent resin film or a polarizer which is oriented within the surface, and then, the polarizer/transparent resin film/coating layer or polarizer/coating layer/transparent resin film are layered in this order, and thereby, a phase retarder integrated polarizer is produced.

In the case where a phase retarder formed of a coating layer that includes an organic modified clay compound is layered on a phase retarder made of a resin film which is oriented within the surface so that a complex phase retarder is gained, and a complex optical member that is layered on an optical layer including a polarizer is used for a liquid crystal display, depolarization occurs, due to the phase retarder made of this coating layer, so that the contrast ratio lowers. Furthermore, in the case where the side of the phase retarder made of this coating layer in such a complex phase retarder or complex optical member is bonded to cell glass of a liquid crystal display using an adhesive, the adhesiveness to the liquid crystal cell glass may lower overtime, due to the phase retarder made of this coating layer.

The present inventors conducted diligent research, and as a result, found that a complex phase retarder where the adhesiveness can be kept high and excellent optical properties are provided when an organic modified clay compound of which the included amount of chlorine is no greater than a certain value is adopted as an organic modified clay compound for use at the time of manufacture of a phase retarder made of a coating layer, and this and a binder resin are contained in an organic solvent, and furthermore, the water content in this liquid is adjusted to a certain value, and the thus gained coating liquid for a coating phase retarder is applied to a transfer base, so that a phase retarder is formed of a coating layer and this is transferred to and layered on a phase retarder made of a resin film using an adhesive, and thereby bonded to a liquid crystal cell. Furthermore, they found that excellent properties can be kept the same even when another optical layer is laminated on this complex phase retarder, and thus, the present invention was achieved.

Accordingly, an object of the present invention is to provide a method for producing a complex phase retarder which is formed of a phase retarder made of a coating layer that includes an organic modified clay compound which is layered on a phase retarder made of a resin film, has biaxial orientation as a whole and adhesiveness which can be kept high when bonded to a liquid crystal cell, and also has excellent optical properties. Another object of the present invention is to provide a method for producing a complex optical member which is appropriate for use in a liquid crystal display by layering an optical layer having another optical function on such a complex phase retarder.

### SUMMARY OF THE INVENTION

The present invention provides a method for producing a complex phase retarder comprising a first phase retarder of at least one resin film, an adhesive layer and a second phase retarder of a coating layer laminated in this order, the method comprising:

preparing a phase retarder with an adhesive where an adhesive layer is formed on a surface of a first phase retarder;

applying on a transfer base a coating liquid containing an organic modified clay compound of which the chlorine content is no greater than 2,000 ppm and a binder resin in an organic solvent where the moisture ratio measured using a Karl Fischer's moisture meter is 0.15 wt % to 0.35 wt %;

forming a second phase retarder by removing the organic solvent and the water from the applied coating liquid;

bonding an exposed surface of the above described second phase retarder to the adhesive layer side of the above described phase retarder with an adhesive;

peeling the transfer base from the above described second phase retarder; and

forming a second adhesive layer on the surface of this second phase retarder from which the transfer base was peeled.

It is advantageous for the first phase retarder to be made of at least one transparent resin film which is oriented within a surface. This first phase retarder has a phase difference value R₀ within the surface, for example, in a range of approximately 10 nm to 300 nm as a whole, and can includes at least one quarter wavelength plate.

A complex phase retarder produced in the above described manner can be converted to a complex optical member by layering an optical layer having another optical function, for example a polarizer, on it. Thus, the present invention also provides a method for producing a complex optical member, the method comprising:

preparing a phase retarder with an adhesive where an adhesive layer is formed on a surface of a first phase retarder of at least one transparent resin film which is oriented within a surface;

applying on a transfer base a coating liquid containing an organic modified clay compound of which the chlorine content is no greater than 2,000 ppm and a binder resin in an organic solvent where the moisture ratio measured using a Karl Fischer's moisture meter is 0.15 wt % to 0.35 wt %;

forming a second phase retarder by removing the organic solvent and the water from the applied coating liquid;

bonding an exposed surface of the above described second phase retarder to the adhesive layer side of the above described phase retarder with an adhesive;

peeling the transfer base from the above described second phase retarder;

forming a second adhesive layer on the surface of this second phase retarder from which the transfer base was peeled, so that a complex phase retarder having a layered structure of first phase retarder/adhesive layer/second phase retarder/second adhesive layer is produced; and

after that, further laminating an optical layer having another optical function on the first phase retarder side of the complex phase retarder.

According to the present invention, a complex phase retarder where a uniaxial or biaxial first phase retarder made of at least one transparent resin film and a second phase retarder made of a coating layer that includes an organic modified clay compound are layered on top of each other or a complex optical member where another optical layer is layered on the first phase retarder side, where the adhesiveness of the adhesive for bonding the liquid crystal cell to the coating phase retarder can be maintained and excellent optical properties, including contrast, are provided, can be advantageously manufactured.

### BRIEF DESCRIPTION OF THE DRAWINGS

FIG. 1 is a is a cross sectional diagram schematically showing a manufacturing method for a complex phase retarder according to one embodiment;

FIG. 2 is a cross sectional diagram schematically showing the steps from the formation of a coating layer up to the formation of a half-finished product by layering this coating layer on a first phase retarder in the case where a complex phase retarder is mass produced in roll form;

FIG. 3 is a cross sectional diagram schematically showing the steps from peeling off of a transfer base from a half-finished product up to the formation of a second adhesive layer on the surface from which the transfer base was peeled in the case where a complex phase retarder is mass produced in roll form;

FIG. 4 is a cross sectional diagram schematically showing an embodiment in the case where the steps from the formation of a coating layer up to the formation of a second adhesive layer are sequentially carried out, and thereby, a complex phase retarder is mass produced in roll form; and

FIG. 5 is a schematic cross sectional diagram showing an example of a complex optical member where a polarizing plate is additionally layered on a complex phase retarder.

[Explanation of Symbols]

10 complex phase retarder
11 first phase retarder
12 adhesive layer
13 phase retarder with adhesive
14 mold release film on first phase retarder
16 half-finished product
17 half-finished product after transfer base is peeled off
20 transfer base
21 second phase retarder made of coating layer
22 second adhesive layer
23 mold release film on second adhesive layer
24 film with adhesive
26 polarizing plate
27 third adhesive layer
28 complex optical member (only polarizing plate is layered in this example)
30 transfer base roll
32 coater for coating layer
34 drying zone for coating layer
36 first phase retarder roll
38 roll for winding mold release film
40 half-finished product roll
41 roll for winding half-finished product
43 roll for peeling transfer base
44 roll for winding transfer base
45 roll for film with adhesive
46 coater for adhesive
47 drying zone for adhesive
48 mold release film roll
50 product roll

### DESCRIPTION OF THE PREFERRED EMBODIMENTS

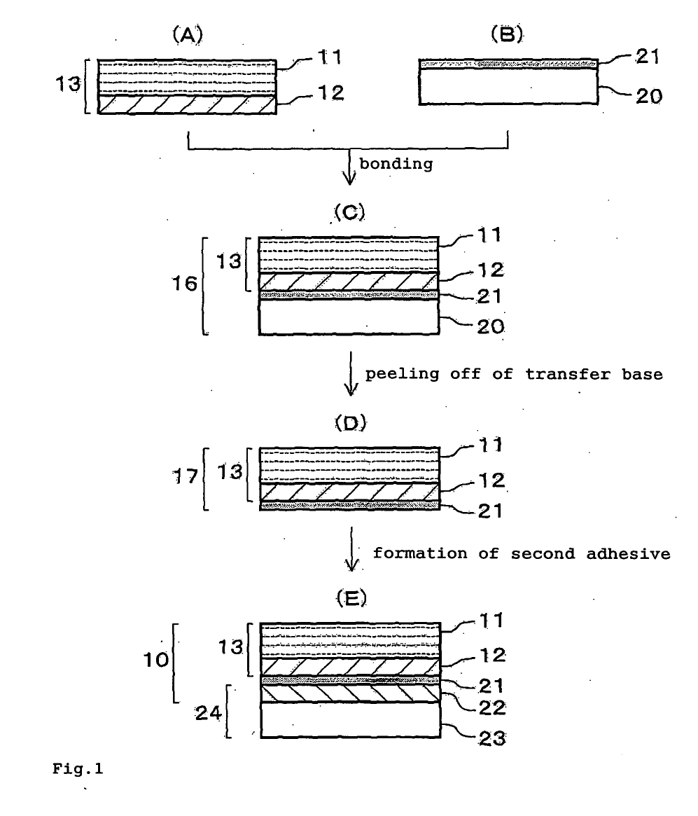

In the following, the embodiments of the present invention are described in detail. FIG. 1 is a schematic cross sectional diagram illustrating the manufacture of a complex phase retarder according to one embodiment of the present invention. The manufacturing method for a complex phase retarder is described in reference to this figure.

As shown in FIG. 1(A), first, a first phase retarder 11, where an adhesive layer 12 is formed on the surface, is prepared. First phase retarder 11 in a state where adhesive layer 12 is formed on the surface is referred to as a phase retarder with an adhesive 13. First phase retarder 11 may be formed of one layer or may be formed of multiple layers having no less than two layers. Meanwhile, as shown in FIG. 1(B), a coating layer 21, which includes an organic modified clay compound and a binder resin and has anisotropy in the index of refraction, is formed on the surface of a transfer base 20. This coating layer 21 becomes a second phase retarder. In this manner, coating layer 21 is formed on transfer base 20, and after that, the exposed surface of coating layer 21, shown in FIG. 1(B), is layered on adhesive layer 12 of first phase retarder 11, shown in FIG. 1(A), and thus, a half-finished product 16 having a layer structure of first phase retarder 11/adhesive layer 12/coating layer (second phase retarder) 21/transfer base 20, shown in FIG. 1(C), is gained.

Next, transfer base 20 is peeled from half-finished product 16, shown in FIG. 1(C), so as to provide a half-finished product 17 after the transfer base has been removed, having a layer structure of first phase retarder 11/adhesive layer 12/coating layer (second phase retarder) 21, shown in FIG. 1(D), and at the same time, a second adhesive layer 22 is formed on the surface of second phase retarder 21 made of this coating layer from which the transfer base has been peeled so as to provide a complex phase retarder 10 having a layer structure of first phase retarder 11/adhesive layer 12/coating layer (second phase retarder) 21/second adhesive layer 22, shown in FIG. 1(E). A mold release film 23 is generally provided to second adhesive layer 22 so as to protect the surface of second adhesive layer 22 and be peeled and removed before second adhesive layer 22 is bonded to another member, for example, a liquid crystal cell. In this case, a film with an adhesive 24 in a state where second adhesive layer 22 is formed on mold release film 23 may be bonded to the surface of second phase retarder 21 made of a coating layer from which the transfer base has been peeled or an adhesive may be applied to the surface of second phase retarder 21 made of a coating layer from which the transfer base has been peeled and dried so as to provide second adhesive layer 22. In the latter case, a mold release film 23 may be layered on second adhesive layer 22 after it has been provided.

As described above, according to the present invention, the step of forming a coating layer 21 on a transfer base 20, and after that, layering the exposed surface of this coating layer 21 on adhesive layer 12 of first phase retarder 11 (which is referred to as first step), and the step of peeling transfer base 20 on thus gained multilayer product (half-finished product 16) from coating layer 21, and at the same time, forming a second adhesive layer 22 on the surface of this coating layer 21 from which the transfer base has been peeled (which is referred to as second step), are carried out in this order. Here, it is preferable in the second step for the peeling off of transfer base 20 and the formation of the second adhesive layer to be carried out sequentially. In the case where such a method is adopted, uneven phase difference, bubbles in an adhesive layer and the addition of foreign substances can be effectively prevented in the gained complex phase retarder.

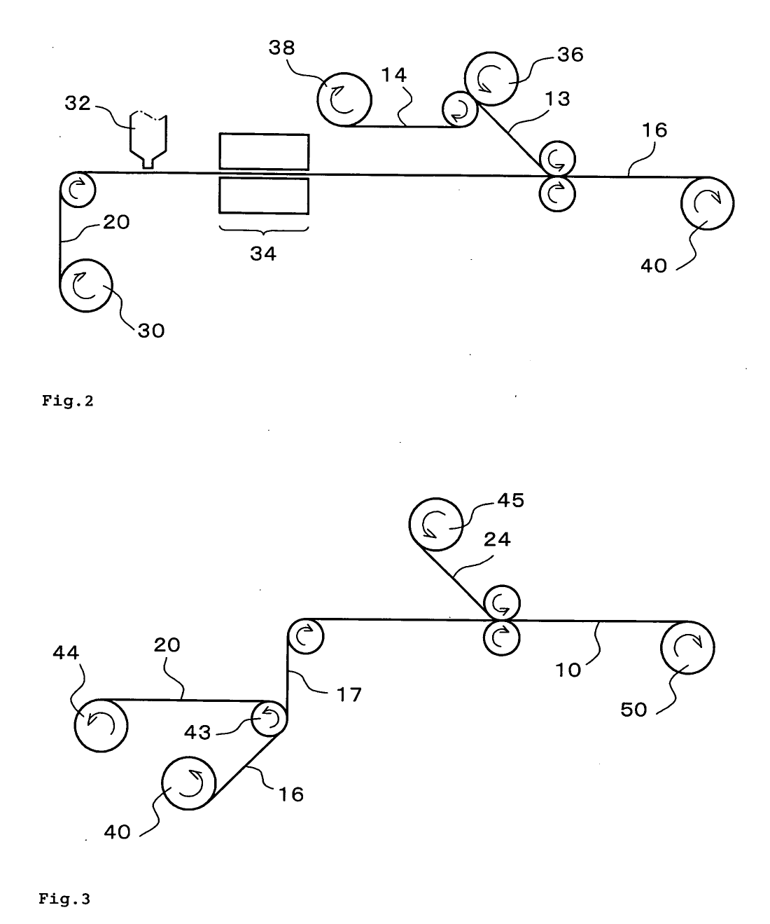

A more concrete embodiment of the first step is described in reference to FIG. 2. FIG. 2 is a schematic cross sectional diagram showing the first step from the formation of a coating layer on a transfer base to the layering of this coating layer on the first phase retarder in a case where a complex phase retarder in rolled form is mass produced. In reference to FIG. 2, a coating liquid for a coating layer is applied to the surface of transfer base 20 that has been pulled out from a transfer base roll 30 using a coater 32, and subsequently, passes through a drying zone 34 so as to be dried, and after that, is supplied for the bonding with a phase retarder with an adhesive (first phase retarder) 13. Phase retarder with an adhesive 13 is generally supplied in a form where a mold release film that can be peeled is bonded to the surface of the adhesive layer, and therefore, mold release film 14 is first peeled from phase retarder with an adhesive 13, which has been pulled out from first phase retarder roll 36, and is rolled up around a mold film winding roll 38. Then, the surface of phase retarder with an adhesive 13 from which the adhesive layer is exposed is bonded to the surface of the coating layer that has been formed on the above described transfer base so that a half-finished product 16 having a layer structure of first phase retarder/adhesive layer/coating layer (second phase retarder)/transfer base is provided and rolled up around a half-finished product roll 40.

In the case where a coating layer is formed on the surface of a certain base and this is layered on another member, in general, a method is possible where a protective film is bonded to the surface of this coating layer, which is exposed to the air, before being rolled up, and furthermore, this process is repeated and the coating layer is bonded to another member while the protective film is being peeled. Compared to such a method that is generally possible, the above described first step has a small number of steps and is advantageous from the point of view of cost, and in addition, it is difficult for defects originated from the unsuccessful separation at the time of peeling off of the protective film and defects due to foreign substances originated from the protective film to occur, and therefore, half-finished product 16 having extremely good quality can be gained.

Next, another concrete embodiment of the second step is described in reference to FIG. 3. FIG. 3 is a schematic cross sectional diagram showing the second step of peeling the transfer base from a half-finished product and forming a second adhesive layer on the surface of the coating layer from which the transfer base has been peeled in the case where a complex phase retarder is mass produced in rolled form. In reference to FIG. 3, half-finished product 16 that has been rolled up around half finished product roll 40 once in the first step shown in FIG. 2 is pulled out from the same roll 40, transfer base 20 is peeled using a transfer base peeling roll 43, and then a film with an adhesive 24 that is pulled out from a roll for a film with an adhesive 45 is supplied to the surface of the exposed coating layer of have finished product 17 after the transfer base has been peeled so that the adhesive layer of the film with an adhesive layer is bonded to the surface of the exposed coating layer, and the two are bonded together so as to be a target complex phase retarder 10 which is then rolled up around a product roll 50. Transfer base 20 that has been peeled from half finished product 16 is rolled up around transfer base winding roll 44. Here, though an embodiment where a film with an adhesive 24 is used for the formation of the second adhesive layer is shown, as described above an adhesive layer may directly be applied to the coating layer.

As described above in the second step, a second adhesive layer 22 is formed, that is to say an adhesive process is carried out, on the surface of a second phase retarder 21 made of a coating layer after transfer base 20 has been peeled from half-finished product 16. After undergoing these first and second steps, a complex phase retarder where the first phase retarder/adhesive layer/second phase retarder/second adhesive layer are provided in this order is gained.

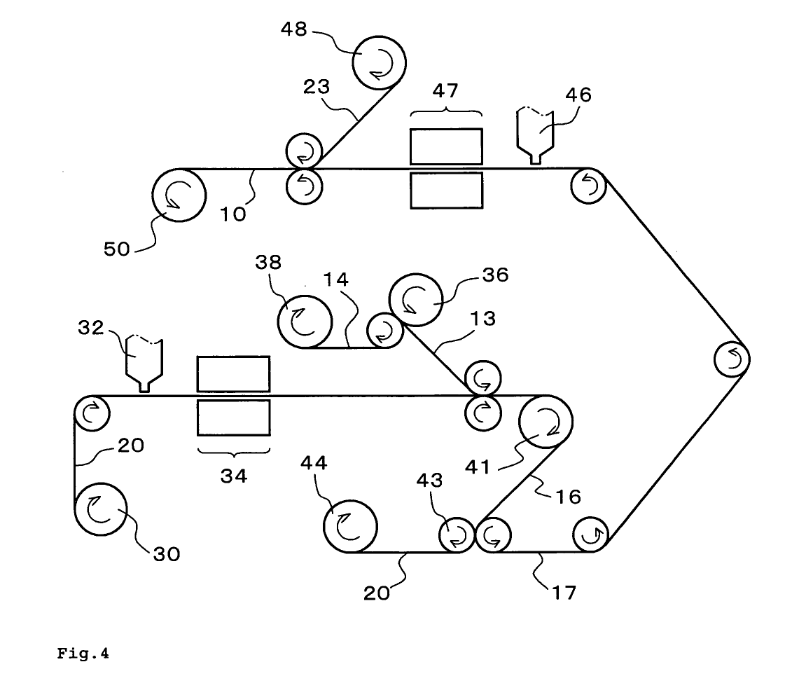

The first step shown in FIG. 2 and the second step shown in FIG. 3 can be carried out sequentially. An embodiment in this case is shown in a schematic side diagram of FIG. 4. In FIG. 4 the same symbols are attached to the portions which are the same as in FIGS. 2 and 3 and the detailed descriptions of these are omitted. In this example, a coating liquid for a coating layer is applied to the surface of transfer base 20 that has been pulled out from transfer base roll 30 using a coater 32, and subsequently, passes through a drying zone 34 so as to be dried, and after that the coating layer side is bonded to the adhesive layer side of a phase retarder with an adhesive 13 after the phase retarder with an adhesive has been pulled out from a first phase retarder roll 36 and mold release film 14 has been peeled from the phase retarder with an adhesive so that a half-finished product 16 having a layer structure of the first phase retarder/adhesive layer/coating layer (second phase retarder)/transfer base is gained and the process up to this point is the same as in the first step shown in FIG. 2.

After that, half-finished product 16 passes through a half-finished product winding roll 41 without being rolled up around the roll and then the transfer base is peeled using a transfer base peeling roll 43, and transfer base 20 that has been peeled is rolled up around a winding roll 44. Meanwhile, an adhesive is applied to the surface of the coating layer of half-finished product 17 after the transfer base has been peeled using an adhesive coater 46 and passes through an adhesive drying zone 47 so as to dry and after that a mold release film 23 which is fed out from a mold release film roll 48 is bonded to the surface to which the adhesive has been applied so that a target complex phase retarder 10 is gained and rolled up around a product roll 50. Though a direct application/drying system where an adhesive coater 46 and a drying zone 47 are used for the formation of the second adhesive layer is shown in this example, a system where a film with an adhesive is used as shown in FIG. 3 can be adopted.

Here, in FIGS. 2 to 4, curved arrows indicate the direction of rotation of the rolls.

When coating layer 21 is left for a long period of time while making contact with transfer base 20, the mold release agent on transfer base 20 transfers to coating layer 21 and the water contact angle on the surface of coating layer 21 after transfer base 20 has been peeled is great. It is preferable to carry out a transfer base peeling and adhesive applying process in the second step under the conditions where the water contact angle on the surface of coating layer 21 after the transfer base has been peeled is greater than the water contact angle on the surface of coating layer 21 that is exposed to the air when coating layer 21 is formed on transfer base 20 [see FIG. 1 (B)] by no greater than 15°, preferably no greater than 10° taking the adhesiveness between the surface of coating layer 21 after transfer base 20 has been peeled and second adhesive layer 22 into consideration. In order to achieve this, it is desirable to proceed to the second step as quickly as possible completion of the first step. In addition, when half-finished product 16 is rolled up, it is a useful technology to roll up half-finished product 16 using a side tape in such a manner that excessive pressure is not applied to half-finished product 16 in order to prevent the mold release agent of transfer base 20 from transferring to coating layer 21 due to the pressure for rolling up. Furthermore, it is a useful technology to carry out corona processing on the surface of either coating layer 21 or second adhesive layer 22 when an adhesive applying process is carried out on coating layer 21 after transfer base 20 has been peeled.

First phase retarder 11 is made of a transparent resin film and though this film is not particularly limited as long as it has a high level of transparency and uniform, a film gained by expanding a thermoplastic resin is preferably used from the point of view of ease of manufacture of the film. As for the thermoplastic resin, cellulose based resins, polycarbonate based resins, polyallylate based resins, polyester based resins, acryl based resins, polysulfone based resins, cyclic polyolefin based resins and the like can be cited as examples. From among these, cellulose based resins, polycarbonate based resins and annular bases resins are preferably used because an inexpensive and uniform film is readily available.

As for the method for producing a film to be expanded in the original roll may be appropriately selected from a solvent casting method, a precise protrusion method according to which residual stress in a film can be reduced and the like. In addition, though the method for expanding a film is not particularly limited, a method for expanding a film uniaxially in the longitudinal direction between rolls according to which uniform optical properties can be gained, a method for expanding a film uniaxially in the lateral direction of a tenter, a method for expanding a film biaxially and the like can be applied. Though the thickness of the first phase retarder is not particularly limited, a plate having a thickness of approximately 50 μm to 500 μm is conventionally used. Here, though the dependency of the phase difference value of this first phase retarder on the wavelength is not particularly limited, it is preferable for the first phase retarder to have a phase difference distribution where the phase difference value becomes smaller as the wavelength becomes shorter.

The phase difference value R₀ within the surface of first phase retarder 11 can be appropriately selected from a range of approximately 10 nm to 300 nm depending on the application of the complex phase retarder. In the case where a complex phase retarder is applied to a relatively compact liquid crystal display such as that of a cellular phone or a portable information terminal, for example, it is advantageous for the first phase retarder to be one quarter wavelength plate. Generally, a uniaxially expanded film is used for one quarter wavelength plate, and therefore, the ratio R₀/R′ of the phase difference value R₀ within the surface to the phase difference value R′ in the direction of the thickness is approximately 2, and for example, in a range from approximately 1.8 to 2.2. Meanwhile, in the case where a complex phase retarder is applied to a relatively large scale liquid crystal display such as a monitor for a desktop type personal computer or a television, the phase difference value R₀ within the surface is in a range from approximately 10 nm to 300 nm and a slightly biaxial phase retarder can be preferably used as the first phase retarder. The relationship between the indices of refraction nₓ>n_{y} and n_{z} in the directions of three axes of the film becomes nₓ>n_{y}>n_{z} as described above in a slightly biaxial phase retarder, and therefore, the ration R₀/R′ of the phase difference value R₀ within the surface to the phase difference value R′ in the direction of the thickness exceeds 0 and is less than 2.

Next, the coating layer on second phase retarder 21 has a negative anisotropy in the index of refraction in the direction of the thickness, and here, a coating layer that can be gained from a coating liquid where an organic solvent contains an organic modified clay compound and a binder resin is adopted.

The organic decorated clay compound is a compound of an organic compound and clay mineral and concretely, clay mineral having a layer structure and an organic compound are combined in the organic decorated clay compound. As for the clay mineral having a layer structure, smectite group, swelling mica and the like can be cited and it becomes possible for the clay mineral to combine with an organic compound through cation exchanging properties thereof. As for the minerals which belong to the smectite group, hectorite, montmorillonite, bentonite, as well as, substitutes, derivatives and mixtures of these can be cited as examples. From among these, chemically synthesized substances have little impurities and a high level of transparency, and thus, are preferable. In particular, synthetic hectorite having a small grain diameter allows the scattering of visible light to be prevented, and therefore, is preferably used.

As for the organic compound that is combined with the clay mineral, compounds which react with oxygen atoms and hydroxyl group in the clay mineral and compounds of which ions can be exchanged with exchangeable cations can be cited, and any of these can be used without particular limitation as long as the resulting organic modified clay compound can be swollen or dispersed in an organic solvent, and concretely, a nitrogen containing compound and the like can be cited. As for the nitrogen containing compound, primary, secondary, and tertiary amines, quaternary ammonium compounds, urea, hydrazine and the like can be cited as examples. From among these quaternary ammonium compounds are preferably used because cation exchange is easy.

As for the quaternary ammonium compounds, ammonium compounds having a long chained alkyl group or having an alkyl ether chain can be cited as examples. From among these, quaternary ammonium compounds having an alkyl group of which the carbon number is 1 to 30, or having—(CH₂CH(CH₃)O)ₙH group or—(CH₂CH₂CH₂O)ₙH group, where n=1 to 50 are preferable. Quaternary ammonium compounds having an alkyl group of which the carbon number is 6 to 10 are even more preferable.

In the case where the organic modified clay compound is formed of an organic compound and clay mineral which belongs to smectite group, though the clay mineral which belongs to the smectite group is not particularly limited as long as it can be swollen or dispersed in an organic solvent in a state of being a compound combined with the organic compound, it is difficult to disperse clay mineral where it is difficult to exchange exchangeable cations with ionic organic compound in an organic solvent. In many cases, a magnesium compound such a magnesium hydroxide, is attached to the surface of the synthetic clay mineral which belongs to smectite group and if the amount of such a magnesium compound is great, it hinders the exchangeable cation site. Therefore, synthetic clay mineral where the magnesium compound on the surface has been removed through washing with acid so that the existence ratio of magnesium is lowered, concretely where the atomic ratio of magnesium to four silicone atoms (Mg/Si₄) is less than 2.73 is easily dispersed in an organic solvent and thus preferable. A typical hectorite which belongs to smectite group is represented in a composition formula of Na_{0.66}(Mg_{5.34}Li_{0.66})Si₈O₂₀(OH)₄·nH₂O or Na_{1/3}(Mg_{8/3}Li_{1/3})Si₄O₁₀(OH)₂·mH₂O as shown in “complete dictionary of chemistry” edited by the committee of editing the complete dictionary of chemistry (Kyoritsu Publishing Co., Ltd., first edition issued on Feb. 28, 1962) and the atomic ratio of Mg/Si₄ in this state is 2.67, while in synthetic hectorite the magnesium compound on the surface has been reduced as described above, and therefore, the atomic ratio of Mg/Si₄ is slightly greater than 2.67.

Such synthetic hectorite where the magnesium compound on the surface has been removed through washing with acid so that the atomic ratio of Mg/Si₄ is made closer to 2.67 as much as possible is preferably used. In smectite group clay mineral which includes hectorite and synthetic hectorite, sodium becomes exchangeable cations which are exchanged with an organic compound, for example, a quaternary ammonium group so that an organic modified clay compound is provided, and therefore, the atomic ratio of Mg/Si₄ does not change before and after decoration. Therefore, it is effective to wash the clay mineral before being decorated with an organic substance with acid in order to make the atomic ratio of Mg/Si₄ of the organic modified clay compound less than 2.73.

Two or more types of organic modified clay compounds can be combined for use. Commercially available products of appropriate organic modified clay compounds include compounds between synthetic hectorite and a quaternary ammonium compound which are sold under respective trade names “Lucentite STN” and “Lucentite SPN” by Co-op Chemical Co., Ltd.

Many organic modified clay compounds have a compound that include chlorine mixed in as an impurity due to a variety of sub-materials which are used at the time of the manufacture thereof. In the case where the amount of such a chlorine compound is great, there is a possibility of bleeding out of the film after a coating phase retarder is formed of such an organic modified clay compound. In this case, adhesiveness deteriorates greatly over time when this coating phase retarder is bonded to liquid crystal cell glass with an adhesive in between. Therefore, in the present invention, an organic modified clay compound where the weight of the chlorine content is no greater than 2,000 ppm is used. In the case where the amount of chlorine that is included in the organic modified clay compound is no greater than 2,000 ppm as described above, deterioration of adhesiveness as described above can be prevented. The chlorine compound can be removed in accordance with a method for cleaning the organic modified clay compound with water.

Though the binder resin is not particularly limited, as long as it dissolves in the below described organic solvents, binder resins having hydrophobicity are preferable in order to gain excellence resistance to heat and ease of handling. As preferable binder resins, polyvinyl acetal resins, such as polyvinyl butyral and polyvinyl formal, cellulose based resins, such as cellulose acetate butyrate, acryl based resins, such as butyl acrylate, methacryl based resins, urethane resins, epoxy resins and polyester resins can be cited as examples. From among these, urethane resins of which the base is aliphatic diiusocyanate can be cited as preferable examples.

Urethane resins of which the base is aliphatic diisocyanate is generated through an additional reaction between an aliphatic compound having a number of isocyanate groups within a molecule and a compound having a number of active hydrogen groups, such as hydroxyl groups, within a molecule. As the aliphatic compound having a number of isocyanate groups within a molecule, hexamethylene diisocyanate, dicyclohexylmethane diisocyanate, cyclohexane diisocyanate, xylylene diisocyanate to which hydrogen is added, isophorone diisocyanate, norbornene diisocyanate and the like can be cited. From among these, those of which the base is isophorone diisocyanate are particularly preferable.

In addition, as the compound having number of hydroxyl groups within a molecule, polyether polyol, polyester polyol, polycarbonate polyol, polycaprolactone polyol and the like can be cited. Though from among these, polyether polyol and polyester polyol are preferable for use, the compound is not limited to these, and a mixture of these may be used.

Polyether polyol is manufactured through, for example, ring opening polymerization or copolymerization of annular ethers, such as ethylene oxide, propylene oxide, trimethylene oxide, butylene oxide, a-methyl trimethylene oxide, 3,3-dimethyl trimethylene oxide, tetrahydrofuran and dioxane, and is also referred to as polyether glycol and polyoxy alkylene glycol.

Polyester polyol is manufactured through condensation polymerization between an organic acid having multiple bases, particularly dicarboxylic acid and polyol. As the dicarboxylic acid, saturated aliphatic acids, such as oxalic acid, succinic acid, glutaric acid, adipic acid, pimelic acid, suberic acid, azelaic acid, sebacic acid and isosebacic acid, unsaturated aliphatic acids, such as maleic acid and fumaric acid, and aromatic carboxylic acids, such as phthalic acid and isophthalic acid, can be cited as examples. Though as the polyol, dioles, such as ethylene glycol, diethylene glycol, triethylene glycol, propylene glycol and butylene glycol, trioles, such as trimethylolpropane, trimethylolethane, hexanetriole and glycerine, and hexaoles, such as sorbitol, can be cited as examples, the polyol is not limited to these, and two or more types may be mixed for use.

It is preferable for the binder resin to have a glass transfer temperature of no higher than 20° C., and it is more preferable for the glass transition temperature to be no higher than −20° C. In the case where the glass transition temperature of the binder resin is high, rubber elasticity becomes insufficient, and adhesiveness and flexibility tend to be inferior in phase retarders and complex polarizing plates where such a phase retarder is layered on a polarizing plate.

The organic solvent used for the coating liquid is not particularly limited, and solvents having high polarity, including ketones, such as acetone, methyl ethyl ketone and methyl isobutyl ketone, lower alcohols, such as methanol, ethanol and propanol, and hydrocarbon halides, such as trichlorocarbon, chloroform, dichloromethane and dichloroethane, in addition to aromatic hydrocarbons having low polarity, such as benzene, toluene and xylene, can be cited as examples. From among these, toluene, xylene, acetone, methyl isobutyl ketone and mixtures of these are preferable in that they make it possible to disperse an organic modified clay compound and dissolve the binder resin, and prevented the coating liquid from being converted to a gel.

An organic modified clay compound and a binder resin as those described above are dissolved in an organic solvent, and thus, a coating liquid for a coating layer can be provided. It is preferable for the organic modified clay compound and the binder resin to be mixed together, so that the weight ratio of the organic modified clay compound/binder resin exceeds 0.5 and is no greater than 3. In the case where the weight ratio in the mixture of the two is outside this range, it tends to become difficult to maintain the haze value of the gained coating phase retarder at a desirable level. It is preferable for the weight ratio in the mixture of the two to be in a range from 1 to 3, and in particular, it is preferable for it to exceed 1 and be no greater than 2.

Though the concentration of the solid in this coating liquid is not limited, as long as the coating liquid is not converted to a gel or cloudy after preparation, and there are practically no problems, a coating liquid of which the total solid concentration of the organic modified clay compound and the binder resin is in a range from approximately 3 wet % to 18 wt % is generally used. The optimal solid concentration differs depending on the respective types of organic modified clay compound and the binder resin, as well as the composition ratio of the two, and therefore, the solid concentration is set for each composition, though it is preferable for it to be in range from 8 wt % to 16 wt %. A variety of additives, such as a viscosity adjustor for increasing the ease of application when a film is formed on a base, or a cross linking agent for increasing the hydrophobicity and/or durability, may be added to this coating liquid.

In the present invention, the moisture ratio of the coating liquid is 0.15 wt % to 0.35 wt %. In the case where the moisture ratio exceeds 0.35 wt %, the water insoluble organic solvent divides into phases and the coating liquid tends divide into two layers. Meanwhile, in the case where the moisture ratio is lower than 0.15 wt %, the haze value of the coating phase retarder formed of this coating liquid tends to be high. It is preferable for the moisture ratio to be no less than 0.18 wt %, it is more preferable for it to be no less than 0.2 wt %, and it is most preferable for it to be no greater than 0.3 wt %. As for the method for measuring the moisture, there is a drying method, a Karl Fischer's method and a dielectric constant method, and in the present invention, the Karl Fischer's method, according to which easy measurement of a microscopic unit is possible, is adopted.

Though the method for adjusting the moisture ratio of the coating liquid to within the above described range is not particularly limited, a method for adding water to the coating liquid is easy and desirable. When an organic solvent, an organic modified clay compound and a binder resin as those used in the present invention are mixed together simply in accordance with a conventional method, the moisture ratio rarely exhibits 0.15 wt % or more. Here, the moisture ratio may become approximately 0.15 wt % in the case where materials that have absorbed moisture are used in the summer. However, even when a coating liquid of which the moisture ratio has become approximately 0.15 wt % due to the moisture absorbed by the material is used, it is difficult to make the haze value of the gained coating phase retarder sufficiently small. Therefore, it is preferable to adjust the moisture ratio to within the above described range by adding a small amount of water to the coating liquid where the organic solvent, the organic modified clay compound and the binder resin are mixed together. Though the method for adding water, which is effective whenever water is added during the preparation process for the coating liquid, is not particularly limited, a method for adding a predetermined amount of water after a certain time has passed after the preparation process for the coating liquid which is then sampled so that the moisture ratio can be measured is preferable, in that the moisture ratio can be controlled with high reproducibility and high precision. Here, the amount of water added in some cases does not coincide with the results of measurement using a Karl Fischer's moisture meter. It is possible that this is because the water partially interacts with the organic modified clay compound (for example, adsorption). Here, it was confirmed that in the case where the moisture ratio measured using a Karl Fischer's moisture meter is kept between the 0.15 wt % and 0.35 wt % prescribed in the present invention, preferably 0.18 wt % and 0.3 wt %, and more preferably 0.2 wt % and 0.3 wt %, the haze value of the gained coating phase retarder can be kept low.

In the case where a solid having a large particle diameter exists in the coating liquid gained by mixing an organic modified clay compound and a binder resin, and in addition, a small amount of water, into an organic solvent, a polarization nullification is caused in the coating difference phase plate fabricated from this coating liquid, which leads to deterioration in the optical performance of the liquid crystal display using this coating phase retarder. In addition, though generally the organic modified clay compound is deflocculated through stirring of the coating liquid, so that the particle diameter becomes smaller, the compound is sometimes not sufficiently deflocculated and there are particles having a large particle diameter, for example, those having a particle diameter of no less than 1 μm, and in this case also, the optical performance of the coating phase retarder deteriorates. Therefore, it is desirable for this coating liquid to be filtered through a filter, so that any such solid that may exist is removed. Here, in this filtering process, the organic modified clay compound that has been deflocculated in the coating liquid must not be removed. It is necessary for the filter to remove almost all solids having a particle diameter of no less than 1 μm, and therefore, it is preferable to select a filter which can remove almost all solids having a particle diameter of no less than 1 μm from among filters in which the diameter of the holes is approximately 0.5 μm to 10 μm, taking change in the particle diameter that can be filtered due to clogging of the filter into consideration. Here, the particle diameter of the deflocculated organic decorative compound is approximately 10 nm to 200 nm.

The thus gained coating liquid which contains an organic modified clay compound, a binder resin, an organic solvent and water where the moisture ratio has been adjusted to within a certain range is applied to a transfer base, and the organic solvent and the water are removed from the coating liquid, and thereby, a second phase retarder is formed. The organic solvent and the water are generally removed through drying after application of the coating liquid.

The layer structure of the unit crystal layer of the organic modified clay compound is randomly oriented in the direction within the surface parallel to the surface of the transfer base as a result of application and drying of the coating liquid as described above. Accordingly, a structure where the index of refraction within the film surface is greater than the index of refraction in the direction of the film thickness can be gained without requiring any special process for orientation.

Transfer base 20 [see FIG. 1(B)] used for the formation of coating layer 21 may be a film on which a process has been carried out so that a layer that is formed on the surface thereof can be easily peeled off. Films on which a mold release process has been carried out by applying a mold release agent, such as a silicone resin or a fluorine resin, to the surface of a resin film, such as polyethylene terephthalate, are generally sold, and therefore, these can be used as they are. In addition, coating layer 21 is formed on transfer base 20, and therefore, it is preferable for transfer base 20 to have a water contact angle with the surface where the coating layer is to be formed in a range from 90° to 130°, and it is more preferable for the water contact angle to be no less than 100° and no greater than 120°. In the case where the water contact angle of the surface is less than 90°, the peeling properties of transfer base 20 are poor, and defects, such as an uneven phase difference, are easily caused in second phase retarder 21 made of a coating layer after the transfer bas has been peeled. In addition, in the case where the water contact angle is greater than 130°, it becomes easy for bubbles to be created in the coating liquid before drying on transfer base 20, and an uneven phase difference in spot form may be created within the surface. Here, the water contact angle is the contact angle when water is used as the liquid, and a greater value (upper limit: 180°) means that it is more difficult for the substance to get wet with water.

The application system used for the formation of coating layer 21 is not particularly limited, and a variety of well known coating methods, such as direct gravure methods, reverse gravure methods, dye coating methods, comma coating methods and bar coating methods can be used. From among these, comma coating methods and dye coating methods which do not use a backup roll are preferably adopted, due to excellence in terms of the precision in the thickness.

Though the temperature and time for drying after application of the coating liquid are not particularly limited, as long as they are sufficient to remove the used organic solvent and water, an appropriate temperature can be selected from approximately 50° C. to 150° C., and the time can be selected from a range of approximately 30 seconds to 30 minutes.

The thickness of the coating layer is not particularly limited, and the thickness may be such that the phase difference value R₀ within the surface can be provided within a range from approximately 0 nm to 10 nm and the phase difference value R′ in the direction of the thickness has a value in a range from approximately 40 nm to 350 nm. Here, in the case where the phase difference value R0 within the surface exceeds 10 nm, this value cannot be ignored, and negative uniaxiality in the direction of the thickness tends to be lost, which is not preferable. In addition, anisotropy in the index of refraction in the direction of the thickness, which is required for second phase retarder 21, which is a coating layer, differs depending on the application of the second phase retarder, and therefore, an appropriate phase difference value R′ in the direction of the thickness can be selected within a range from approximately 40 nm to 350 nm on the basis of the application, particularly the properties of the liquid crystal cell. The phase difference value R′ in the direction of the thickness is preferably no less than 50 nm and no greater than 300 nm.

The anisotropy in the index of refraction in the direction of the thickness of the phase retarder is represented by the phase difference value R′ in the direction of the thickness, as defined in the above described formula (II), and this value can be calculated from the phase difference value R₄₀ which is measured by inclining the delay phase axis within the surface by 40 degrees as an inclining axis and the phase difference value R₀ within the surface. That is to say, the phase difference value R′ in the direction of the thickness in formula (II) can be calculated by finding nₓ, n_{y} and n_{z} through numeral calculation using the following formulas (III) to (V) using the phase difference value R₀ within the surface, the phase difference value R₄₀, which is measured by inclining the delay phase axis by 40 degrees as an inclining axis, the thickness d of the film and the average index of refraction n₀ of the film, inserting these in the above described formula (II).
R₀=(nₓ−n_{y})×d (III)
R₄₀=(nₓ−n_{y}′)×d/cos (f) (IV)
(nₓ+n_{y}+n_{z})/3=n₀ (V)

Here, f =sin⁻¹ [sin (40°)/n₀]
n_{y}′=n_{y}×n_{z}/[n_{y}²×sin²(f)+n_{z}²×cos²(f)]^{1/2}

In the case where a coating layer having anisotropy in the index of refraction which is formed on a transfer base and includes an organic modified clay compound and a binder resin is once transferred onto a glass plate using an adhesive, R₀ and R₄₀ of this coating layer (second phase retarder) can be directly found and the phase difference R′ in the direction of the thickness calculated in accordance with the above described method on the basis of R₀ and R₄₀.

In addition, as the adhesive used for adhesive layer 12 formed on the surface of first phase retarder 11 shown in FIG. 1(A) and the like and second adhesive layer 22 formed on the surface of coating layer 21 from which the transfer base is peeled in the second step shown in FIG. 1(E), acryl based polymers, silicone based polymers and adhesives of which the base polymer is polyester, polyurethane, polyether or the like can be cited. It is preferable to select and use from among these an adhesive such as an acryl based adhesive having high optical transparency, the ability to keep appropriate wettability and cohesion, excellent adhesiveness to the base, and in addition, resistance to weather and resistance to heat, so that no problems such as lifting or peeling are caused under conditions where heat is applied or humidity is applied. As the base polymer of the acryl based adhesive, an acryl based copolymer of which the weight average molecular weight is no less than 100000 gained by mixing together alkyl ester of (meth) acrylic acid having an alkyl group of which the carbon number is no greater than 20, such as a methyl group, an ethyl group or a butyl group, and an acryl based monomer containing a functional group made of (meth)acrylic acid, hydroxyethyl (meth) acrylate or the like so that the transition temperature becomes no higher than 25° C., preferably no higher than 0° C., and then polymerizing these is useful. Generally the thickness of adhesive layers 12 and 22 is approximately 5 μm to 30 μm.

An optical layer having optical properties other than the phase difference properties is additionally layered on a complex phase retarder gained as described above, so that a complex optical member can be provided. As for the optical layer that is layered on a complex phase retarder for the purpose of forming a complex optical member, conventional members used for the formation of a liquid crystal display or the like, such as polarizing plates and brightness increasing films, can be cited as examples. It is effective for the optical layer having optical properties other than the phase difference properties to include at least a polarizing plate.

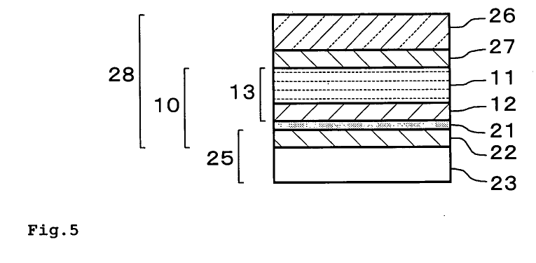

A combination of a complex phase retarder and a polarizing plate can be used both as a linear polarizing plate to which a view angle compensating function is provided and a circular polarizing plate. When the combination is used as a linear polarizing plate, it is preferable for the delay phase axis of the first phase retarder to be perpendicular to the absorption axis of the polarizing plate. In addition, in the case where the combination is used as a circular polarizing plate, the delay phase axis of the first phase retarder crosses the absorption axis of the polarizing plate at a certain angle. FIG. 5 shows an example of a complex optical member 28 where a polarizing plate 26 is layered on the first phase retarder 11 side of complex phase retarder 10 shown in FIG. 1(E) (mold release film 23 is provided on the outside of second adhesive layer 22 on complex phase retarder 10) with a third adhesive layer 27 in between. As shown in this figure, an optical layer having other optical properties, such as polarizing plate 26, is layered on the first phase retarder 11 side of complex phase retarder 10.

A phase retarder of which the phase difference value is quarter wavelength for single color light of a certain measured wavelength between, for example, 540 nm to 560 nm (hereinafter referred to as λ/4 plate) is used as first phase retarder 11, and in the case where only one λ/4 plate made of a general expanded resin film is used, the range of wavelengths where completely circular polarization can be gained is often limited. For this reason, there are two methods for gaining circular polarization in a wide range of wavelengths. According to the first method, at least one phase retarder of which the phase difference value is half wavelength for single color light having a certain measured wavelength between, for example, 540 nm and 560 nm, which is the same as above, (hereinafter referred to as λ/2 plate) and at least one λ/4 plate are layered so as to form a first phase retarder 11 which is a λ/4 plate of a so-called wide band, and polarizing plate 26 is layered on this. In addition, according to the second method, a λ/4 plate with so-called reverse wavelength dispersion of which the phase difference value is approximately ¼ of the measured wavelength for any wavelength from among the measured wavelengths between 400 nm and 800 nm is used.

First, the first method is described. According to this method, circular polarization can be gained in a wider wavelength range by increasing the number of first phase retarders used while the cost for the materials increases and the yield decreases as the number of bonded plates increases, and therefore, a circular polarizing plate where one λ/2 plate and one λ/4 plate are bonded together so as to form a λ/4 plate of a wide band, and a polarizing plate is bonded to this is preferable, from the point of view of cost efficiency. As for the phase difference value R_{1/2}, within the surface of the λ/2 plate and the phase difference value R_{1/4}, within the surface of the λ/4 plate, R_{1/2}=250 nm to 300 nm and R_{1/4}=120 nm to 155 nm for single color light having a measured wavelength between 540 nm and 560 nm. In addition, it is preferable for R_{1/2} and R_{l/4} to have the following relationship.
|R_{1/2}×0.5−R_{1/4}|=10 nm

When a polarizing plate, at least one λ/2 plate and at least one λ/4 plate are bonded together, the order of layers and the set angles are not particularly limited, as long as the setting allows the layered plate to function as a circular polarizing plate for a wide range of wavelengths. In the case where, for example, one λ/2 plate and one λ/4 plate are used, the λ/2 plate and the λ/4 plate may be layered in this order so as to form a first phase retarder, and the polarizing plate/first phase retarder/second phase retarder are layered in this order, or the polarizing plate/second phase retarder/first phase retarder may be layered in this ordered. As for the preferable layer angles in this case, the following settings are possible when the angles are defined as the angles of the delay phase axes of the phase retarders using the absorption axis of the polarizing plate as a reference, and the counter-clockwise direction as viewed from the polarizing plate side is positive.

(1) −10° to −20° for the λ/2 plate and −70° to −80° for the λ/4 plate

(2) 70° to 80° for the λ/2 plate and 10° to 20° for the λ/4 plate

(3) 10° to 20° for the λ/2 plate and 70° to 80° for the λ/4 plate

(4) −70° to −80° for the λ/2 plate and −10° to −20° for the λ/4 plate

Next, the second method is described. The phase difference value R_{1/4} within the surface of the above described λ/4 plate of the reverse wavelength dispersion is generally 120 nm to 155 nm, and preferably 130 nm to 150 nm for single color light having a wavelength between 540 nm to 560 nm. In addition, as is clear from the above description, it is preferable for R_{1/4} to be within the above described range for all measured wavelengths between 400 nm and 800 nm. When the polarizing plate and the λ/4 plate are bonded together, though the angle formed between the absorption axis of the polarizing plate and the delay phase axis of the phase retarder is basically 45° or 135°, there are no particular limitations in terms of the allowed range for these angles, as long as the bonded plates function as a circular polarizing plate for wavelengths in the visible light range. The layers may be either polarizing plate/first phase retarder/second phase retarder or polarizing plate/second phase retarder/first phase retarder.

As a technology, it is useful to additionally combine the multilayer body of a polarizing plate and a complex phase retarder with a brightness increasing film. Brightness increasing films have such properties as to reflect linearly polarized light having a certain polarization axis or circular polarized light in a certain direction and transmit polarized light in the opposite direction from among light that is emitted from the backlight and natural light which is reflected from a reflective plate on the rear side or the like of the liquid crystal display, and are used for the purpose of increasing the brightness. That is to say, light reflected from this brightness increasing film is reflected from a reflective layer or the like which is placed on the rear side of the brightness increasing film with the state of polarization reversed, so that the entirety or most of the light transmits through this brightness increasing film when the light reenters the brightness increasing film, and thus, light is effectively used and the brightness of the display can be increased. As examples of the brightness increasing film, reflective linear polarization separating sheets designed so that anisotropy is provided in the index of refraction by layering a number of thin films having different anisotropies in the index of refraction, oriented films of a cholesteric liquid crystal polymer, circular polarization separating sheets where an oriented liquid crystal layer of such an oriented film is supported on a film base and the like can be cited.

A diffusing adhesive can be used on the surface where a complex phase retarder and a liquid crystal cell make contact with each other. Diffusion adhesives are for adhesive layers containing microscopic particles having the ability to scatter light. The microscopic particles used here are not particularly limited, as long as they can scatter light, and both organic particles and inorganic particles can be used. As organic particles, particles made of a polyolef in based resin, such as polystyrene, polyethylene or polypropylene, and a polymer compound, such as an acryl based resin, can be cited, and the particles may be of a cross linked polymer. Furthermore, a copolymer where two or more types of monomers selected from among ethylene, propylene, styrene, methyl methacrylate, benzoguanamine, formaldehyde, melanin and butadiene are copolymerized can be used. As inorganic particles, particles of silica, silicone, titanium oxide and the like can be cited as examples, and the particles may be glass beads. Though it is preferable for these microscopic particles to be colorless or white, colored microscopic particles having a decorative function may be used.

Though the form of the microscopic particles is not particularly limited, spherical form, spindle form and forms close to cubic can be cited as preferable forms. If the particle diameter is no small, the function of light scattering cannot be achieved, while if the particle diameter is too large, the quality of liquid crystal displays where such particles are used deteriorates, and therefore, it is preferable for the particle diameter to be no less than 0.5 μm and no greater than 20 μm, and it is more preferable for it to be no less than 1 μm and no greater than 10 μm. An appropriate amount can be set for the microscopic particles added on the basis of the degree of light scattering desired. In general, the amount is no less than 0.01 weight parts and no greater than 100 weight parts relative to 100 weight parts of the adhesive used as a dispersion medium, and preferably the microscopic particles are mixed with a ratio of no less than 1 weight part and no greater than 50 weight parts.

The type of adhesive used for the dispersing adhesive is not particularly limited, and any well-known adhesive, such as acryl based adhesives, vinyl chloride based adhesives and synthetic rubber based adhesives can be used. in the case where such a dispersing adhesive is placed between the complex phase retarder and the liquid crystal cell, this dispersing adhesive may be used as the above described second adhesive layer [symbol 22 in FIG. 1(E)].

Examples of the structure of circular polarizing plates using a complex phase retarder when a complex phase retarder gained according to the present invention is applied to a liquid crystal display are shown in the following. The circular polarizing plates are placed so that an optimal combination can be selected taking into consideration performance and cost: only on the front side in the case where the liquid crystal cell is of a reflective type, on both sides; front and rear, in the case of a semi-transmissive reflective type, and either on the front side or the rear side in the case of a transmissive type.

1. Examples of Structure on Front Side for Reflective Type

(1) polarizing plate/adhesive/first phase retarder (λ/4 plate)/adhesive/second phase retarder/adhesive/front side of liquid crystal cell
(2) polarizing plate/adhesive/first phase retarder (reverse wavelength dispersion λ/4 plate)/adhesive/second phase retarder/adhesive/front side of liquid crystal cell
(3) polarizing plate/adhesive/first phase retarder (λ/2 plate +λ/4 plate)/adhesive/second phase retarder/adhesive/front side of liquid crystal cell
(4) polarizing plate/adhesive/first phase retarder (λ/4 plate)/adhesive/second phase retarder/dispersing adhesive/front side of liquid crystal cell
(5) polarizing plate/adhesive/first phase retarder (reverse wavelength dispersion λ/4 plate)/adhesive/second phase retarder/dispersing adhesive/front side of liquid crystal cell
   2. Examples of Structure on Front Side for Semi-Transmissive Reflective Type
(1) polarizing plate/adhesive/first phase retarder (λ/4 plate)/adhesive/second phase retarder/adhesive/front side of liquid crystal cell
(2) polarizing plate/adhesive/first phase retarder (reverse wavelength dispersion λ/4 plate)/adhesive/second phase retarder/adhesive/front side of liquid crystal cell
(3) polarizing plate/adhesive/first phase retarder (λ/2 plate +λ/4 plate)/adhesive/second phase retarder/adhesive/front side of liquid crystal cell
(4) polarizing plate/adhesive/first phase retarder (λ/4 plate)/adhesive/second phase retarder/dispersing adhesive/front side of liquid crystal cell
(5) polarizing plate/adhesive/first phase retarder (reverse wavelength dispersion λ/4 plate)/adhesive/second phase retarder/dispersing adhesive/front side of liquid crystal cell
(6) polarizing plate/adhesive/first phase retarder (λ/2 plate +λ/4 plate)/adhesive/second phase retarder/dispersing adhesive/front side of liquid crystal cell
   3. Examples of Structure on Rear Side for Semi-Transmissive Reflective Type
(1) polarizing plate/adhesive/first phase retarder (λ/4 plate)/adhesive/second phase retarder/adhesive/rear side of liquid crystal cell
(2) polarizing plate/adhesive/first phase retarder (reverse wavelength dispersion λ/4 plate)/adhesive/second phase retarder/adhesive/rear side of liquid crystal cell
(3) polarizing plate/adhesive/first phase retarder (λ/2 plate +λ/4 plate)/adhesive/second phase retarder/adhesive/rear side of liquid crystal cell
(4) brightness increasing film/polarizing plate/adhesive/first phase retarder (λ/4 plate)/adhesive/second phase retarder/dispersing adhesive/rear side of liquid crystal cell
(5) brightness increasing film/polarizing plate/adhesive/first phase retarder (reverse wavelength dispersion λ/4 plate)/adhesive/second phase retarder/dispersing adhesive/rear side of liquid crystal cell
(6) brightness increasing film/polarizing plate/adhesive/first phase retarder (λ/2 plate +λ/4 plate)/adhesive/second phase retarder/dispersing adhesive/rear side of liquid crystal cell
   4. Example of Structure on Front Side for Transmissive Type
(1) polarizing plate/adhesive/first phase retarder/adhesive/second phase retarder/adhesive/front side of liquid crystal cell
   5. Examples of Structure on Rear Side for Transmissive Type
(1) polarizing plate/adhesive/first phase retarder/adhesive/second phase retarder/adhesive/rear side of liquid crystal cell
(2) brightness increasing film/polarizing plate/adhesive/first phase retarder/adhesive/second phase retarder/adhesive/rear side of liquid crystal cell

In a state where a complex phase retarder or a complex optical member gained according to the present invention is bonded to the cell glass of a liquid crystal cell via a second adhesive layer, it is desirable for the adhesiveness this second adhesive layer to the liquid crystal cell glass to be difficult to change over time. The adhesiveness is the force created through contact between the adhesive surface of the adhesive sheet and the surface of the body to be bonded, and a method for testing this is prescribed in JIS Z 0237. In a phase retarder fabricated from a coating liquid where an organic modified clay compound having a high chlorine content is mixed into an organic solvent together with a binder resin, the adhesiveness sometimes is a great deal lower after some time has passed, in comparison with the adhesiveness immediately after bonding to the liquid crystal cell glass using an adhesive. For this reason, an organic modified clay compound of which the chlorine content has been lowered through washing with water after manufacture is used, and therefore, the coating layer (second phase retarder) gained from a coating liquid into which such an organic modified clay compound is mixed has little reduction in the adhesiveness over time when it is bonded to liquid crystal cell glass using an adhesive. Concretely, no less than 60%, and furthermore, no less than 80% of the adhesiveness of the coating layer immediately after bonding can be maintained after storage for one month at 23° C. in a state where complex phase retarder 10 shown in FIG. 35 1(E) or complex optical member 28 shown in FIG. 5 is bonded to liquid crystal cell glass via second adhesive layer 22.

### EXAMPLES

Though in the following, the present invention is described in further detail using examples, the present invention is not limited to these examples. In the examples, %, ppm and parts, which indicate the content or amount of use, are weight units unless otherwise stated. The materials used for the preparation of coating liquids in the following examples are shown below.

(A) Organic Modified clay Compound

trade name “Lucentite STN,” made by Co-op Chemical Co., Ltd.; compound of synthetic hectorite and trioctyl methyl ammonium ions

(B) Binder Resin

trade name “SBU” Lacquer 0866,” made by Sumika Bayer Urethane AG; urethane resin varnish having a base of isophorone diisocyanate and a solid concentration of 30%

In addition, the property values of the samples were measured and evaluated in accordance with the following method.

(1) Moisture Ratio

The moisture ratio of the coating liquid was measured using a Karl Fischer's moisture meter “KFT Titrino Type 795,” made by Metrohm AG. Here, a mixed solvent of 55% chloroform and 45% ethylene chlorohydrin was used for measurement.

(2) Phase Difference Value R₀ within Surface

The coating layer formed on the transfer base was transferred onto a square glass plate of 4 cm with an adhesive in between. The phase difference value R₀ within the surface of the coating layer in a state of being bonded to the glass plate in this manner was measured in accordance with a rotating analyzing method for single color light having a wavelength of 559 nm using “KOBRA-21ADH,” made by Oji Scientific Instruments Co., Ltd. The phase difference value R₀ within the surface of the phase retarder made of an expanded resin film was directly used using the above described “KOBRA-21ADH.”

(3) Phase Difference Value R′ in Direction of Thickness nₓ, n_{y} and n_{z} were found in accordance with the above described method, using the phase difference value R₀ within the surface, the phase difference value R₄₀ measured by inclining the plate by 40° using the delay phase axis as an inclining axis, the thickness d of the phase retarder and the average index of refraction n₀ of the phase retarder, and then, the phase difference value R′ in the direction of the thickness was calculated using the above described formula (II).

(4) Adhesiveness

The complex phase retarder was cut into a rectangle having a width of 25 mm and a length of approximately 250 mm and bonded to liquid crystal cell glass, and after that, a process for applying pressure was carried out at a temperature of 50° C. for 20 minutes under a pressure of 5 kgf/cm² using an autoclave. Next, a measuring instrument “Autograph AG-1,” made by Shimadzu Corporation, was used to measure the adhesiveness through peeling at 180° C. at a pulling rate of 300 mm/min.

### Example 1

A coating liquid was prepared with the following composition.

urethane resin varnish “SBU Lacquer 0866”: 16.0 parts

organic modified clay compound “Lucentite STN”: 7.2 parts

toluene: 76.8 parts

water: 0.3 parts

Undecorated synthetic hectorite was manufactured, and after that, washed with acid, and then decorated with an organic substance, and furthermore, thoroughly washed with water by the maker, and in this state, the organic modified clay compound used was gained. The amount of chlorine included in the organic modified clay compound was 1,111 ppm, and the atomic ratio of Mg/Si₄ was 2.69 (values as measured by the maker). This coating liquid was filtered with a filter having a hole diameter of 1 μm after the above described composition was mixed and stirred. In this coating liquid, the solid weight ratio of the organic modified clay compound/urethane resin was 1.5/1 and the solid concentration was 12%. The coating liquid had a moisture ratio of 0.25%, as measured using a Karl Fischer's moisture meter, after 0.3 parts of water was added. Next, this coating liquid was continuously applied to a polyethylene terephthalate film having a thickness of 38 μm on which a mold release process was carried out using a dye coater, and dried in a drying oven. When the film came out of the oven, a continuous λ/4 plate (first phase retarder, trade name “Sumikalight CSES430120Z6,” made by Sumitomo Chemical Co., Ltd., R₀=120 nm) made of a cyclic polyolefin based expanded resin film having an adhesive layer on one side was bonded to the exposed surface of the coating layer (second phase retarder) on the adhesive layer side, and then, the film was rolled up, and thus, a half-finished product made of first phase retarder/adhesive layer/second phase retarder/mold release film was provided. The phase difference value of the coating layer sampled was measured before bonding to the λ/4 plate, and it was found that R₀=0.1 nm and R′=82 nm.

After this, the above described half-finished product was unrolled while peeling off the mold release film, and a separate, continuous polyethylene terephthalate film where an adhesive was applied to the surface on which a mold release process was carried out was bonded to the surface of the coating layer on the adhesive layer side after the mold release film was peeled off, and thus, a complex phase retarder made of first phase retarder/adhesive layer/second phase retarder/second adhesive layer/mold release film was gained. The mold release film was peeled off from this complex phase retarder, which was then bonded to liquid crystal cell glass, and then, the adhesiveness was measured in accordance with the above described method, and it was found that the adhesiveness to glass was 9.07 N/25 mm. In addition, the adhesiveness of the complex phase retarder was 9.04 N/25 mm after storage for one week at 23° C. in a state of being bonded to the liquid cell glass, and 8.99 N/25 mm after storage for one month at the same temperature. That is to say, no less than 99% of the adhesiveness to glass immediately after bonding to the liquid crystal cell glass was maintained both after storage for one week and after storage for one month at 23° C.

Furthermore, a polyvinyl alcohol-iodine based polarizing plate having an adhesive layer on one side (trade name “Sumikalan SRW842A,” made by Sumitomo Chemical Co., Ltd.) was prepared and bonded to a complex phase retarder gained as in the above, so that the late phase axis of the complex phase retarder formed an angle of 45° with the absorption axis of the polarizing plate and the adhesive layer of the polarizing plate was layered on the first phase retarder of the above described complex phase retarder, and thus, a circular polarizing plate having a diagonal size of 2 inches (38.2 mm×30.7 mm) was fabricated.

### Comparative Example 1

A coating liquid was prepared so as to have the following composition.

urethane resin varnish “SBU Lacquer 0866”: 7.5 parts

organic modified clay compound “Lucentite STN”: 6.8 parts

toluene: 85.7 parts

Undecorated synthetic hectorite was manufactured, and after that, washed with acid, and then decorated with an organic substance, and furthermore, thoroughly washed with water by the maker, and in this state, the organic modified clay compound used was gained, and the amount of chlorine included in the organic modified clay compound was 3,379 ppm, and the atomic ratio of Mg/Si₄ was 2.73 (values as measured by the maker). This coating liquid was filtered with a filter having a hole diameter of 1 μm after the above described composition was mixed and stirred. In this coating liquid, the solid weight ratio of the organic modified clay compound/urethane resin was 3/1 and the solid concentration was 9%. In addition, this coating liquid had a moisture ratio of 0.13%, as measured using a Karl Fischer's moisture meter. Next, this coating liquid was continuously applied to a polyethylene terephthalate film having a thickness of 38 μm on which a mold release process was carried out using a dye coater, and dried in a drying oven. When the film came out of the oven, a continuous λ/4 plate (first phase retarder, trade name “SumikalightCSES440120Z7,” made by Sumitomo Chemical Co., Ltd., R₀=120 nm) made of a cyclic polyolefin based expanded resin film having an adhesive layer on one side was bonded to the exposed surface of the coating layer (second phase retarder) on the adhesive layer side, and then, the film was rolled up, and thus, a half-finished product made of first phase retarder/adhesive layer/second phase retarder/mold release film was provided. The phase difference value of the coating layer sampled was measured before bonding to the λ/4 plate, and it was found that R₀=0.1 nm and R′=82 nm.

After that, the above gained half finished product was used to fabricate a complex phase retarder made of first phase retarder/adhesive layer/second phase retarder/second adhesive layer/mold release film in the same manner as in Example 1. the mold release film was peeled off from this complex phase retarder, which was then bonded to liquid crystal cell glass, and the adhesiveness was measured, and it was found that the adhesiveness to glass was 11.18 N/25 mm. In addition, the adhesiveness of the complex phase retarder was 2.86 N/25 mm after storage for one week at 23° C. in a state of being bonded to the liquid cell glass. That is to say, the adhesiveness to glass lowered to 26% after storage for one week at 23° C., as compared to immediately after bonding to the liquid crystal cell glass.

Furthermore, this complex phase retarder was used to fabricate a circular polarizing plate in the same manner as in Example 1.

What is claimed is:

1. A method for producing a complex phase retarder comprising a first phase retarder of at least one resin film, an adhesive layer and a second phase retarder of a coating layer laminated in this order, the method comprising:
preparing a phase retarder with an adhesive where an adhesive layer is formed on a surface of a first phase retarder;
applying on a transfer base a coating liquid containing an organic modified clay compound of which the chlorine content is no greater than 2,000 ppm and a binder resin in an organic solvent where the moisture ratio measured using a Karl Fischer's moisture meter is 0.15 wt % to 0.35 wt %;
forming a second phase retarder by removing the organic solvent and the water from the applied coating liquid;
bonding an exposed surface of the above described second phase retarder to the adhesive layer side of the above described phase retarder with an adhesive;
peeling the transfer base from the above described second phase retarder; and
forming a second adhesive layer on the surface of this second phase retarder from which the transfer base was peeled.

2. The method according to claim 1, wherein the first phase retarder is at least one transparent resin film which is oriented within a surface.

3. The method according to claim 2, wherein the first phase retarder comprises at least one quarter wavelength plate.

4. A method for producing a complex optical member, the method comprising:
preparing a phase retarder with an adhesive where an adhesive layer is formed on a surface of a first phase retarder of at least one transparent resin film which is oriented within a surface;
applying on a transfer base a coating liquid containing an organic modified clay compound of which the chlorine content is no greater than 2,000 ppm and a binder resin in an organic solvent where the moisture ratio measured using a Karl Fischer's moisture meter is 0.15 wt % to 0.35 wt %;
forming a second phase retarder by removing the organic solvent and the water from the applied coating liquid;
bonding an exposed surface of the above described second phase retarder to the adhesive layer side of the above described phase retarder with an adhesive;
peeling the transfer base from the above described second phase retarder;
forming a second adhesive layer on the surface of this second phase retarder from which the transfer base was peeled; and
laminating an optical layer having another optical function on the first phase retarder side of the complex phase retarder.

5. The method according to claim 4, where the optical layer having another optical function includes at least a polarizer.
